(19) United States
(12) Patent Application Publication
(10) Pub. No.: US 2002/0087662 A1
(43) Pub. Date: Jul. 4, 2002

(54) System and method for selective updating of media files

(76) Inventor: Stephane Bouet, Tokyo-To (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/750,142

(22) Filed: Dec. 29, 2000

(51) Int. Cl. G06F 15/16

(52) U.S. Cl. 709/219; 709/207; 709/250

(57) ABSTRACT

A media content delivery system and a process of updating files in a database of a media content delivery system. The media content delivery system includes a database for storing media files, a user input device for selecting media files in the database to be outputted, an output device for outputting of selected media files, an external data interface for receiving media files, an integrated circuit card interface adapted to hold an integrated circuit card having encoded thereon criteria for accepting media files for storage in the database, and a controller responsive to selection by the user input device of one of the media files stored in the database, to apply the selected media file to the output device for outputting, and responsive to receipt by the external data interface of media files, to store in the media database only media files received by the external data interface which meet criteria on an integrated circuit card in the integrated circuit card interface. The process of updating files in a database of a media content delivery system includes the steps of receiving at the media content delivery system an integrated circuit card having encoded thereon criteria for selecting media files, receiving at the media content delivery system at least one media file, and storing in the database of the media content delivery system only media files received at the media content delivery system which meet the criteria on the integrated circuit card.

### FIELD OF THE INVENTION

The present invention pertains to a media content delivery system permitting selective updating of media files, and to a selective method of updating files in a media content delivery system. More particularly, the present invention pertains to a system for and a method of automatically selecting from media files downloaded to a media content delivery system those files that are to be stored at the media content delivery system based on the content of the files.

### BACKGROUND OF THE INVENTION

The automatic distribution of media content is becoming widely available. By way of example, publically available media terminals are often provided in such locations as shopping malls, hotel lobbies, airports, and convenience stores to enable people to access audio or video material without the need for a sales representative. A kiosk in such a location might permit a person to select files by means of an input device such as a keyboard or a mouse. A wireless application protocol (WAP) server might provide selection of files through a wireless connection, for example a Bluetooth connection, from a customer's mobile phone or other wireless device. Details of the Bluetooth technology can be found in “Specification of the Bluetooth System,” available on the Internet at www.bluetooth.com. A kiosk or other terminal might provide various types of media files, for example music, video games, books, newspapers, movies, etc. Further, different genres might be provided such as popular music, rock-and-roll music, blues music, classical music, etc., or such as fiction books, poetry books, biographies, etc., or such as financial newspapers, tabloids, big city newspapers, foreign newspapers, etc. In addition, such media terminals might permit access to e-mail by travelers who do not have other means of receiving e-mail intended for them.

In such a media terminal, a person wishing to access a media file can select from available media files and access the selected file in various forms, for example by means of load speakers or headphones or by means of a video screen, or by downloading the media file in electronic form. Customers' preferences in particular media files change with time. Thus, for example, a particular piece of popular music might be much in demand for some period of time, but then decline in popularity while other, newer pieces of popular music gain in popularity. Similarly, different video media files might be popular for certain periods of time, but then decline in popularity while being replaced by later video media files. For example, a video game might remain popular for several months, but a newspaper may require updating daily. Further, e-mail must be made available only to its intended recipient.

As a consequence, the media files available at a media terminal require frequent updating so as to assure that currently popular files are available. Updating of the media files available at a particular media terminal might be achieved in any of several manners. By way of examples, a compact disc read only memory (CD ROM), a digital video disc (DVD) or a computer disk might be sent to the proprietor of the kiosk at periodic intervals with updated files. The files can then be read into a database at the kiosk from the CD ROM, the DVD, or the computer disk. Alternatively, the media files stored in a Bluetooth terminal might be updated through a network, either a wire network or a wireless network, from a remote source such as a server or a main frame computer. As used herein, “wire connection” includes any type of wire or cable and also optical fiber. The updating might then occur automatically, for example at periodic intervals such as once a week or once a month.

Different media terminals might be located in environments populated by persons with different interests. For example, a kiosk located in a shopping mail might attract younger people with tastes for video games and for a particular genre of music, while a kiosk located in a lobby area of a large hotel or in an airport terminal building might attract older persons having preferences for a different genre of music and possibly no interest in video games, but an interest in newspapers and in receiving e-mail. The distributor of the media files, however, is likely to provide the files to a large number of kiosks, some of which want to make available media files of a certain type or certain genre, while others want to make available media files of another type or genre. Accordingly, the proprietor of the media terminal needs a method of accepting certain media files for availability at the terminal, while rejecting other media files. This can be done by the proprietor indexing through the offered media files and accepting those of the desired type or genre, while rejecting others. Doing this, however, is a time consuming process, and is subject to error. In addition, if the file updating is done automatically, then the media terminal proprietor must index through the offered files at that time, even though he or she might not be easily available then. If the update files are provided by a CD ROM, DVD, or computer disk, then the CD ROM, DVD, or computer disk can be customized for each media terminal. However, this is an expensive and time-consuming effort. Alternatively, the media terminal might include a controller programmed with particular criteria for accepting media files of a particular type or genre so as to enable automatic selection of the desired types and genres of files, while rejecting files of other types or genres. However, if the customer base that utilizes the media terminal changes over time, either due to changing demographics or due to movement of the terminal to a different location, then the criteria within the terminal's controller either are no longer compatible, which significantly reduces the value of the terminal, or must be changed, which is a time consuming and expensive process. Further, at a media terminal permitting access to e-mail, e-mail intended for one recipient must not be freely available, but must be made available only to that recipient.

The following summarizes some of the prior art systems for downloading media files from a remote source to a kiosk:

Published PCT Application No. PCT/US99/20789 (International Publication No. WO 00/30117), the disclosure of which is incorporated herein by reference, shows a system for downloading music from a publically available terminal or kiosk to a self-contained personal music device for subsequent playback, with the kiosk being activated in response to insertion of a credit card or cash. The music files available at the kiosk are updated either by a person visiting the kiosk to service it or remotely by a wireless server or over a public phone line.

U.S. Pat. No. 5,734,719, the disclosure of which is also incorporated herein by reference, discloses a system for downloading media files from a remote database to a kiosk at which a compact disc or a magnetic tape of the media file can be made. The files are not stored in the kiosk.

U.S. Pat. No. 5,754,939, the disclosure of which is also incorporated herein by reference, discloses a system in which a customer utilizes his or her own personal computer to access and download electronic media files. The system notes the customer's selections and builds a database about the customer's preferences, enabling the system to offer suggestions to the customer each time the customer accesses the system.

U.S. Pat. No. 5,758,257, the disclosure of which is also incorporated herein by reference, shows a system for making media files available to customers in which the system captures information about each customers' selections and then uses that information to build a customer profile for each customer. When a previous customer returns, the system might suggest media files which the customer's previous selections, as incorporated in the customer profile, indicate the customer might like.

U.S. Pat. No. 5,875,175, the disclosure of which is also incorporated herein by reference, discloses a system in which a customer scans a card into a kiosk, and the kiosk generates discount coupons targeted to the customer based on data the kiosk has accumulated about the customer's purchasing habits.

U.S. Pat. No. 5,953,725, the disclosure of which is also incorporated herein by reference, discloses a media kiosk in which the contents are periodically updated remotely.

U.S. Pat. No. 5,963,916, the disclosure of which is also incorporated herein by reference, shows a system, in which each customer is issued an integrated circuit card (a “smart card,”) which the customer uses to activate a kiosk from which music files are accessible. The kiosk stores samples of various music files, and when the customer selects a file for complete accessing, the full file is transmitted from a remote database to the kiosk.

U.S. Pat. No. 6,032,130, the disclosure of which is also incorporated herein by reference, discloses a kiosk from which catalog information can be accessed regarding products for sale. Large volumes of fixed information, such as product descriptions, are stored at the kiosk, while smaller volumes of time-variable information, such as product prices, are provided to the kiosk from a remote site.

### SUMMARY OF THE INVENTION

The present invention is a media content delivery system permitting selective updating of media files, and a method of updating media files in media content delivery system in which the media content delivery system receives an integrated circuit card having encoded on it criteria for accepting media files for storage in a database, while rejecting other media files. The criteria encoded on the integrated circuit card might specify a particular type of media, such as text, video games, or music, and further might indicate a particular genre of the selected type of media. The media content delivery system includes a database storing a plurality of media files, a user or customer input device permitting a customer or other user to select media files to be accessed, an output device for outputting the selected media files, an integrated circuit card interface adapted to hold an integrated circuit card having encoded thereon criteria for accepting media files for storage in the database, an external data interface for receiving media files, and a controller responsive to selection by the customer input device of one of the media files stored in the database to apply the selected media file to the output device for outputting thereof, and responsive to receipt by the external data interface of media files to store in the media database only those media files received by the external data interface which meet criteria on an integrated circuit card held in the integrated circuit card interface.

The user or customer input device might be a keyboard or a mouse. Likewise, it might be an electronic input device such as a Bluetooth connection or a wire connection, permitting the user or customer to select files with the user's mobile phone, notebook computer, or other device, or might be a combination of these.

The external data interface might be a wire or wireless connection to a remote source or might be a CD ROM drive, a DVD drive, or a disk drive. The output device can be a video output device, an audio output device, an electronic output device, or some combination of these. The media content delivery system might also include a proprietor input device enabling the proprietor of the system to initiate the downloading of media files from a remote source to the external data interface and to otherwise control the system.

The method of updating media files in a database of a media content delivery system in accordance with the present invention includes the steps of receiving at the media content delivery system an integrated circuit card having encoded thereon criteria for selecting media files, receiving at the media content delivery system at least one media file, and storing in the database of the media content delivery system only media files received at the media content delivery system which meet the criteria on the integrated circuit card.

### BRIEF DESCRIPTION OF THE DRAWINGS

These and other aspects and advantages of the present invention are more apparent from the following detailed description and claims, particularly when considered in conjunction with the accompanying drawings in which like parts bear like reference numerals. In the drawings:

FIG. 1 is a block diagram of a media content delivery system in accordance with a preferred embodiment of the present invention;

Each of FIGS. 2-7 is a block diagram illustrating some of the possible alternative embodiments of a media content delivery system in accordance with the present invention; and

FIG. 8 is a flowchart of a method of delivering media content in accordance with a preferred embodiment of the present invention.

### DETAILED DESCRIPTION OF PREFERRED EMBODIMENT

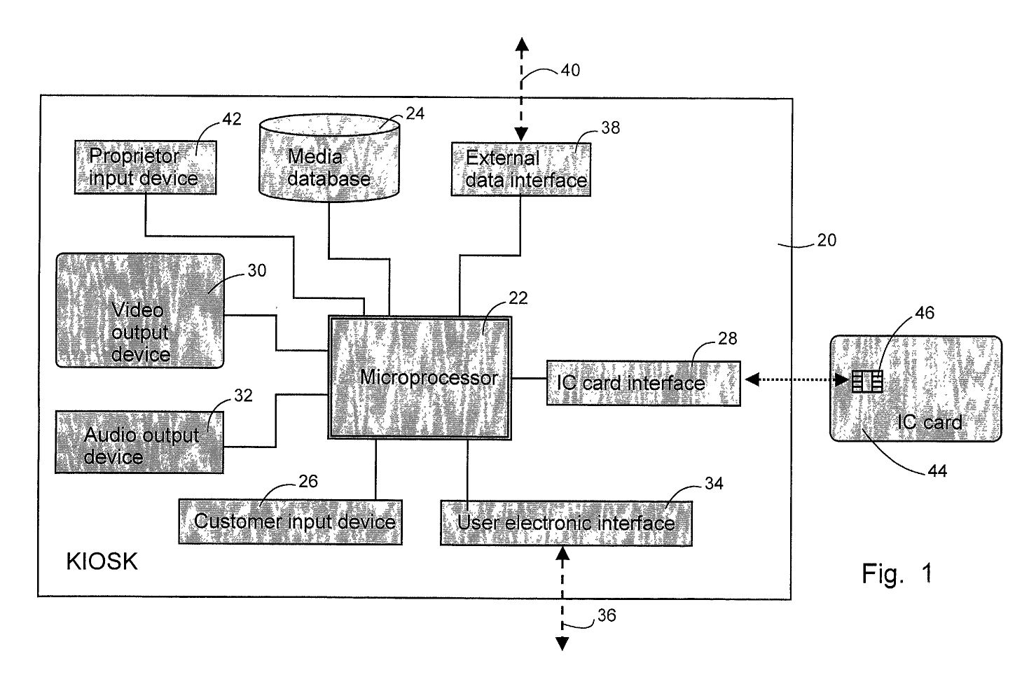

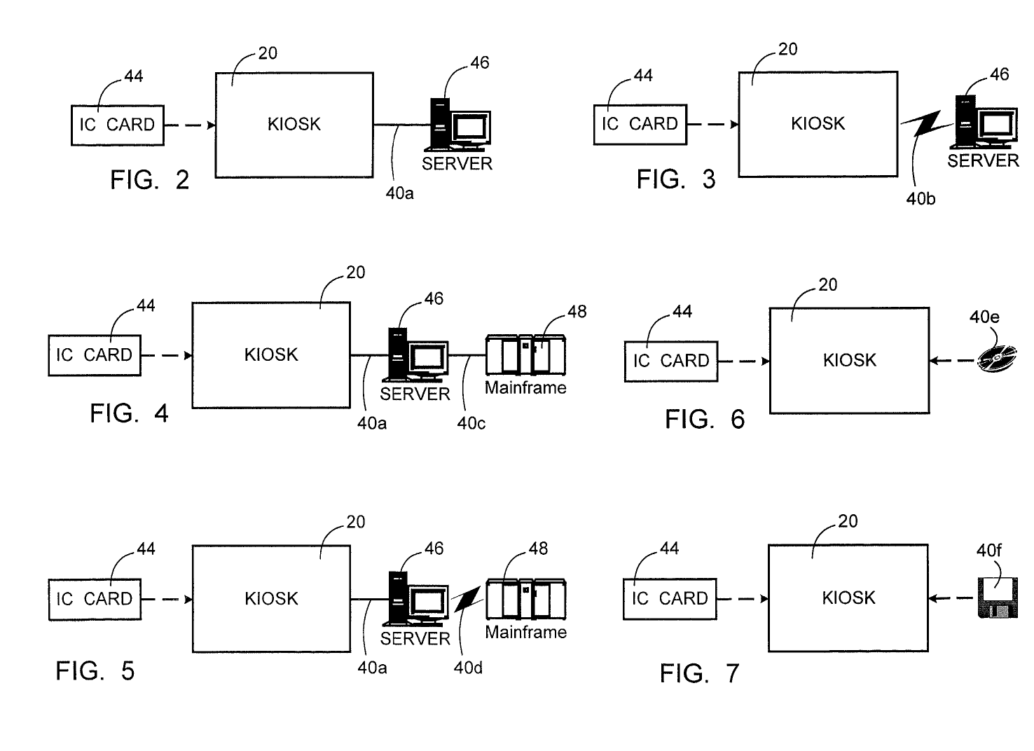

FIG. 1 is a block diagram of a media content delivery system in accordance with a preferred embodiment of the present invention. The media content delivery system of FIG. 1 comprises a media terminal or kiosk 20 within which a microprocessor 22 is connected to a media database 24, an integrated circuit (IC) card interface 28, a video output device 30, an audio output device 32, a user electronic interface 34 permitting input of control signals and output of media in electronic form via a link 36, and an external data interface 38 permitting electronic communication with a remote location via a link 40. Additionally, microprocessor 22 can be connected to a user or customer input device 26 and to a proprietor input device 42, if desired. The customer input device 26 and user electronic interface 34 are accessible by customers using media terminal 20, and outputs provided on video output device 30 and audio output device 32 can be seen and heard by those customers. IC card interface 28 and proprietor input device 42 preferably are accessible only by the proprietor on unlocking and opening of the media terminal. External data interface 38 is capable of communication via link 40 with an external source of media files, under control of microprocessor 22, permitting updating of the files stored in media database 24. External data interface 38 preferably is not accessible by customers, but preferably is accessible by the proprietor or other authorized personnel, for example for servicing.

When a customer or other user wishes to access media from media database 24, the customer might use user or customer input device 26 to select the media files to be accessed. By way of example, a menu of available media files might be provided on video output device 30, and the customer might select a file to be accessed using the customer input device 26. In addition, the customer might use the input device 26 to select the form of output. That is, the customer might indicate whether the output is to be provided at video output device 30, audio output device 32, or user electronic interface 34. Alternatively, the customer might use his or her own notebook computer, mobile phone or other wireless device to apply his or her selections of media files and of input format through user electronic interface 34, in which event no user or customer input device 26 need be provided. If the output is to be provided at video output device 30, then the video media is displayed on that device. Such a display might be a movie or a clip from a movie, text, or a video game during which the customer would use user or customer input device 26 to play the game. Any audio that accompanies the video would be provided through audio output device 32. If the media file being accessed is strictly an audio file, for example music, then the output is provided only through audio output device 32 which might be one or more load speakers or a pair of headphones. If the media file is to be outputted in electronic form, then the file is outputted through user electronic interface 34 to communication link 36 by which it might be applied to an appropriate device of the customer, for example to a laptop computer or to a wireless personal terminal, such as a palm pilot. Communication link 36 might be a wire connection or a wireless connection.

When the media files within database 24 are to be updated, new files are received through external interface 38. When new files are to be received, an integrated circuit card 44 is inserted into IC card interface 28. IC card 44 has encoded on it criteria 46 indicating the types of media files to be accepted by media terminal 20. This coding might indicate types of files, such as music files, movie files, video game files, text files, etc. In addition, the encoding might indicate the particular genre of music, movies, text, etc. to be accepted. Microprocessor 22 then compares the media files applied through external data interface 38 with the criteria 46 on integrated circuit card 44 and allows those files which meet those criteria, and so are acceptable, to be stored in media database 24. To provide additional security, the criteria 46 can be encrypted using a symmetric or an asymmetric encryption algorithm, with the necessary keys encrypted on the IC card in a tamper resistant manner.

IC card 44 might be left within IC card interface 28 for an indefinite period of time if desired, so long as it is secure from pilfering or tampering. Alternatively, the proprietor of media terminal 20 can insert IC circuit card 44 into IC circuit card interface 28 each time the media files are to be updated, and remove it following such updating. The updating might take place at regular predetermined intervals of time, such as weekly or monthly. Alternatively, the proprietor of media terminal 20 can determine when updating is to be done and apply commands to microprocessor 22 by way of proprietor input device 42 to cause the microprocessor to request updating from the file source. Proprietor input device 42 can be a keyboard, a mouse, or a wireless or wire connection to a mobile phone, a laptop computer or another appropriate device, for example. As another alternative, microprocessor 22 can monitor the files requested through user input device 26, and based on predetermined criteria can determine that one or more files, genre of files, or types of files are not being accessed on a frequent enough basis, and so can initiate updating to replace those files.

If desired, when updating is to take place microprocessor 22 can cause the acceptance criteria 46 to be transmitted through external data interface 38 and link 40 to the file source so that the acceptance criteria are applied there, and then only files that meet those criteria are transmitted to media terminal 20. These files will then be promptly stored in media database 24. By having the acceptance decision made at the file source, less data needs to be transmitted over link 40 to external data interface 38 from the source.

FIGS. 2-7 illustrate some of the various sources from which files can be provided to media terminal 20 by way of external data interface 38. FIGS. 2-7, however, are by no means exhaustive of the various sources that might be used. FIG. 2 shows a media terminal in the form of a kiosk 20 connected to a server 46 by a wire link 40a. This might be done in a local area network, for example. FIG. 3 illustrates that the server 46 might be connected to kiosk 20 by a wireless connection 40b, for example in a wide area network. In either event, server 46 provides update files to kiosk 20 through the external data interface 38 of the kiosk. FIG. 4 illustrates that server 46 can be connected to a larger source of files such as a main frame computer 48 through a wire connection 40c. FIG. 5 illustrates the connection of server 46 to main frame computer 48 by a wireless connection 40d. In either case, the connection between kiosk 20 and server 46 can be either a wire connection or a wireless connection.

Rather than a wire or wireless connection from a remote source, external data interface 38 can be a CD ROM drive or a DVD drive to receive a compact disc or digital video disc 40e as illustrated in FIG. 6. Likewise, external data interface 38 can be computer disk drive to receive a computer disk 40f as illustrated in FIG. 7. Any other suitable source of providing updated files to the media terminal kiosk 20 might also be utilized.

If media terminal 20 is to permit a customer to receive e-mail, then the customer inserts his or her own IC card 44 into IC card interface 28. The customer's IC card 44 has criteria 46 encoded on it which identify the customer and his or her e-mail address. The customer then uses customer input device 26 to connect external data interface 38 and link 40 to an external data source such as server 46 or mainframe computer 48 to obtain the customer's e-mail, based on the customer's identification and e-mail address as encoded in criteria 46. Preferably, microprocessor 22 requires the customer to input a password at customer input device 26 before outputting the e-mail, or even before acquiring the e-mail through external data interface 38 and link 40.

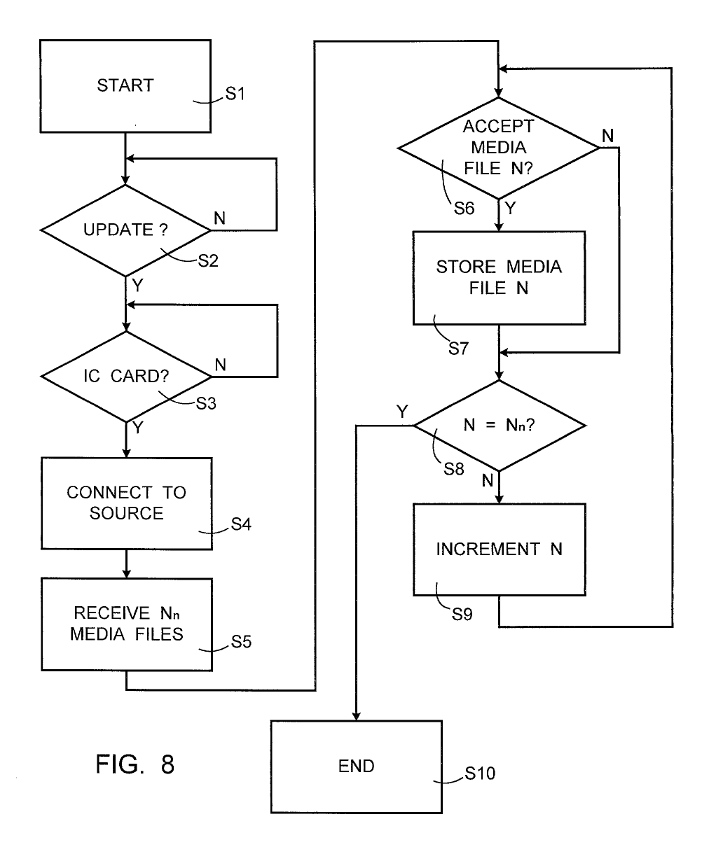

FIG. 8 sets forth steps in the process of updating files in a database of a media content delivery system in accordance with the present invention. The process starts in step S1, and in step S2 it is determined whether an update is to be done. As set forth above, this might be based on the time since the last update or on the receipt of a command through proprietor input device 42 or the sensing that certain files are not being accessed frequently. If an update is not to take place, the process simply repeats step S2. When an update is to take place, the process waits for receipt of an integrated circuit card 44 at integrated circuit card interface 28 in step S3. If desired, controller 22 can activate an indicator such as a light on the kiosk to indicate that an IC card is required to permit updating to be done. Once the IC card 44 is received, then in step S4 the media terminal 20 connects to the file source. This might be any of the sources illustrated in FIGS. 2-7, or any other suitable source. In step S5 the media terminal 20 receives a number Nₙ of files from the source through external data interface 38. In step S6, microprocessor 22 determines whether the first file N meets the acceptance criteria encoded on integrated circuit 44. If so, then in step S7 that first file N is stored in media database 24, and in step S8 it is determined whether the last file has been received; that is, whether N=Nₙ. If not, then the number N is incremented. The process then returns to step S6, and it is determined whether the next file meets the acceptance criteria. If in step S6 it is determined that the file does not meet the acceptance criteria, then the process goes to step S8 to determine whether that was the last file, without storing that file. When step S8 determines that N=Nₙ, and so the last file has been checked for acceptance, the process ends in step S10.

It is thus seen that the present invention provides a media content delivery system permitting selective updating of media files, and also a selective method of updating media files in a media content delivery system. Although the invention has been described with reference to preferred embodiments, various rearrangements, alterations, and substitutions can be made, and still the result will be within the scope of the invention.

What is claimed is:

1. A media content delivery system, comprising:
a database for storing a plurality of media files;
a user input device for selecting media files in said database to be outputted;
an output device for outputting of selected media files;
an external data interface for receiving media files;
an integrated circuit card interface adapted to hold an integrated circuit card having encoded thereon criteria for accepting media files for storage in said database; and
a controller responsive to selection by said user input device of one of the media files stored in said database, to apply the selected media file to said output device for outputting, and responsive to receipt by said external data interface of media files, to store in said media database only media files received by said external data interface which meet criteria on an integrated circuit card held in said integrated circuit card interface.

2. A media content delivery system as claimed in claim 1, wherein said user input device comprises a keyboard.

3. A media content delivery system as claimed in claim 1, wherein said user input device comprises a mouse.

4. A media content delivery system as claimed in claim 1, wherein said user input device comprises an electronic interface.

5. A media content delivery system as claimed in claim 1, wherein said output device comprises a video output device.

6. A media content delivery system as claimed in claim 1, wherein said output device comprises an audio output device.

7. A media content delivery system as claimed in claim 1, wherein said output device comprises an electronic interface.

8. A media content delivery system as claimed in claim 1, wherein said external data interface comprises a wire connection.

9. A media content delivery system as claimed in claim 8, further comprising a server connected to said wire connection.

10. A media content delivery system as claimed in claim 9, further comprising a computer connected to said server.

11. A media content delivery system as claimed in claim 1, wherein said external data interface comprises a wireless connection.

12. A media content delivery system as claimed in claim 11, further comprising a server connected to said wireless connection.

13. A media content delivery system as claimed in claim 12, further comprising a computer connected to said server.

14. A media content delivery system as claimed in claim 1, wherein said external data interface comprises a compact disc read only memory drive.

15. A media content delivery system as claimed in claim 1, wherein said external data interface comprises a digital video disc drive.

16. A media content delivery system as claimed in claim 1, wherein said external data interface comprises a computer disk drive.

17. A media content delivery system as claimed in claim 1, wherein said integrated circuit card interface is adapted to hold an integrated circuit card having encoded thereon criteria identifying an e-mail address, and said external data interface is adapted to receive e-mail for the identified e-mail address.

18. A media content delivery system as claimed in claim 1, further comprising an integrated circuit card having encoded thereon criteria for accepting media files for storage in said database.

19. A media content delivery system as claimed in claim 18, wherein the criteria are encrypted.

20. A media content delivery system as claimed in claim 18, wherein the criteria include an e-mail address.

21. A media content delivery system as claimed in claim 1, further comprising a kiosk housing said database, said user input device, said output device, said integrated circuit card interface, said external data interface, and said controller.

22. A process of updating files in a database of a media content delivery system, said process comprising the steps of:
(a) receiving at the media content delivery system an integrated circuit card having encoded thereon criteria for selecting media files;
(b) receiving at the media content delivery system at least one media file; and
(c) storing in the database of the media content delivery system only media files received at the media content delivery system which meet the criteria on the integrated circuit card.

23. A process as claimed in claim 22, wherein step (b) comprises connecting the media content delivery system to an external data source, and receiving the at least one media file from the external data source.

24. A process as claimed in claim 23, wherein step (b) comprises connecting the media content delivery system to the external data source by a wire connection.

25. A process as claimed in claim 23, wherein step (b) comprises connecting the media content delivery system to the external data source by a wireless connection.

26. A process as claimed in claim 23, wherein step (b) comprises connecting the media content delivery system to a server.

27. A process as claimed in claim 23, wherein step (b) comprises connecting the media content delivery system to a computer.

28. A process as claimed in claim 22, wherein step (b) comprises receiving an audio file.

29. A process as claimed in claim 22, wherein step (b) comprises receiving a video file.

30. A process as claimed in claim 29, wherein step (b) comprises receiving a video game.

31. A process as claimed in claim 29, wherein step (b) comprises receiving a movie.

32. A process as claimed in claim 29, wherein step (b) comprises receiving a text file.

33. A process as claimed in claim 32, wherein the text file is a newspaper.

34. A process as claimed in claim 32, wherein the text file is an e-mail file.

35. A process as claimed in claim 22, wherein the media content delivery system includes a compact disc read only memory drive, and step (b) comprises inserting a compact disc read only memory into the compact disc read only memory drive, and receiving the at least one media file from the compact disc read only memory.

36. A process as claimed in claim 22, wherein the media content delivery system includes a digital video disc drive, and step (b) comprises inserting a digital video disc into the digital video disc drive, and receiving the at least one media file from the digital video disc.

37. A process as claimed in claim 22, wherein the media content delivery system includes a computer disk drive, and step (b) comprises inserting a computer disk into the computer disk drive, and receiving the at least one media file from the computer disk.
